(19) United States
(12) Patent Application Publication
(10) Pub. No.: US 2019/0377456 A1
(43) Pub. Date: Dec. 12, 2019

(54) FLEXIBLE NANOWIRE TOUCH SCREEN

(71) Applicant: INTEL CORPORATION, Santa Clara, CA (US)

(72) Inventors: Dong Yeung Kwak, San Jose, CA (US); Jue Li, Shanghai (CN); Ramon C. Cancel Olmo, Hillsboro, OR (US)

(73) Assignee: INTEL CORPORATION, Santa Clara, CA (US)

(21) Appl. No.: 16/479,933

(22) PCT Filed: Feb. 24, 2017
(86) PCT No.: PCT/CN2017/074761

§ 371 Date: Jul. 23, 2019

(51) Int. Cl. G06F 3/044

(52) U.S. Cl. CPC G06F 3/0445; G06F 2203/04103; G06F 2203/04102

(57) ABSTRACT

An apparatus that includes a touch sensor is provided. The touch sensor includes a busbar region including busbar lines formed from metallic nanowires at a first density.

### TECHNICAL FIELD

The present techniques relate generally to relate to the field of computing devices. More specifically the present techniques relate to flexible sensors for touch screen displays.

### BACKGROUND

Small electronic devices, such as mobile phones, tablets, and laptops, among other, have become ubiquitous in society. However, devices may be limited by screen size, and fragility. Generally, current devices cannot be bent or folded without damaging the touchscreen, including the touch sensor. A widely used material in touch sensors for small devices is indium tin oxide (ITO), due to transparency. However, ITO has high resistance, is brittle, and has a high manufacturing cost. These properties may be limiting factors for flexible applications and larger size touch sensors.

Other systems may provide viable solutions for flexible applications, such as metal mesh touch sensors. Metal mesh touch sensors may provide some flexibility to touch sensors. However, optical issues, like the formation of Moiré patterns and haze, may occur due to non-transparent metal line pitch. Further, the metal mesh technologies generally use a photolithography process to fabricate the fine pitch sensor lines, making the costs high.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1(A) is a drawing of an example of a component that may be used in a touch sensor, according to an embodiment.

FIG. 1(B) is a drawing of a second component of a touch sensor that includes dummy patterns, according to an embodiment.

FIGS. 2(A) and 2(B) are drawings of examples of touch sensor structures, according to embodiments.

FIGS. 3(A) and 3(B) are drawings of an example of a touch sensor including a touch sensor transmitter and a touch sensor receiver that may be used in embodiments.

FIG. 4 is a drawing of an example of the use of lower density SNW for the touch sensor patterns in a viewing area and higher density SNW in the busbar lines, according to embodiments.

FIG. 5(A) is a drawing of an example of an electron micrograph of a low density SNW region, according to an embodiment.

FIG. 5(B) is a drawing of an example of an electron micrograph of a high density SNW region, according to an embodiment.

FIG. 6 is a schematic diagram of an example of forming a touch sensor using different densities of SNW solutions for forming conductors in a touch sensor region than in a busbar region, according to an embodiment.

FIG. 7 is a process flow diagram of an example of a method for forming a touch sensor using different densities of SNW for a touch sensor and for a busbar, according to an embodiment.

FIG. 8 is a block diagram of an example of a computing device that may use the touch sensor described herein, according to an embodiment.

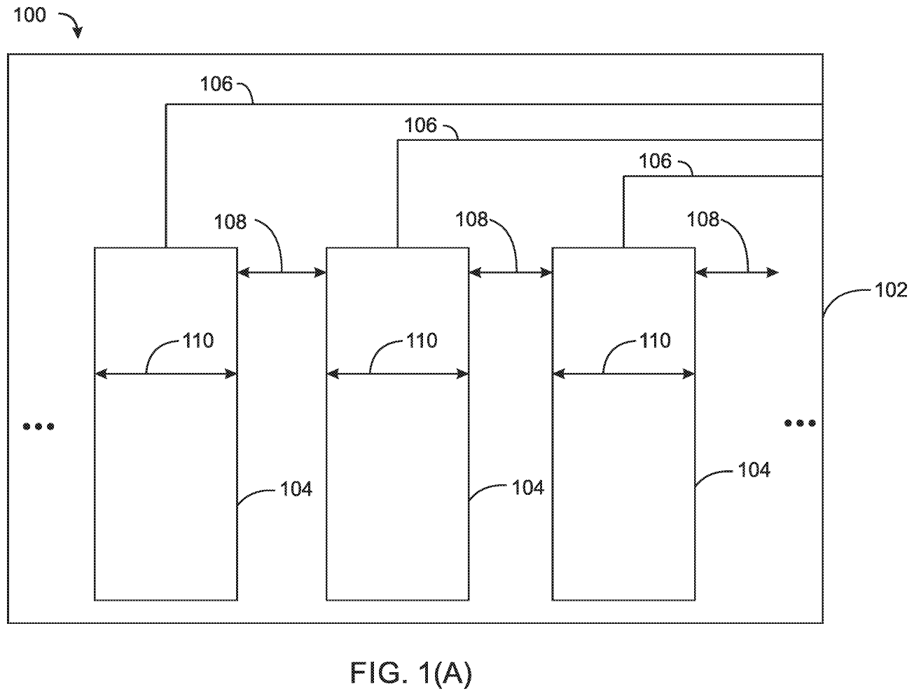

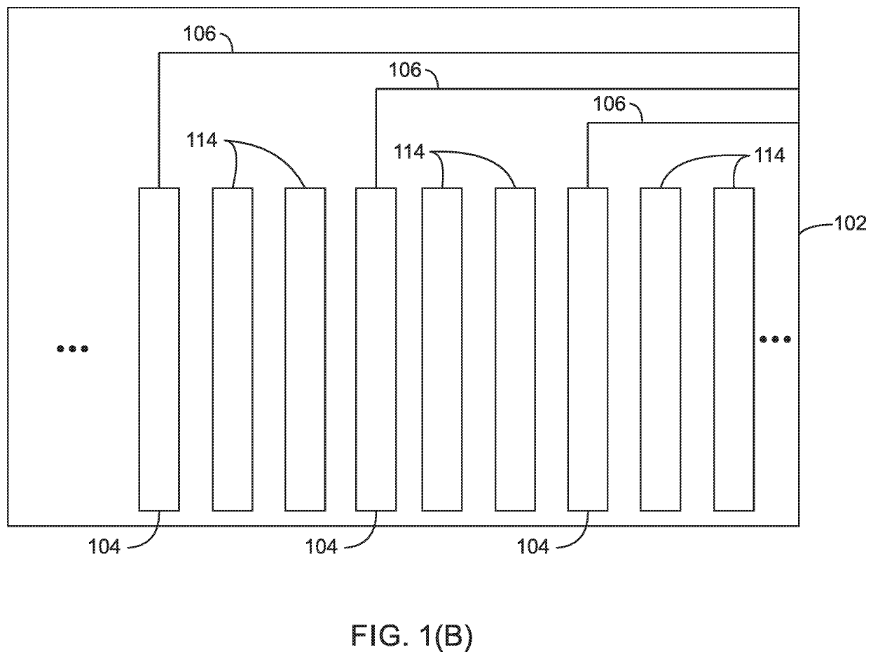

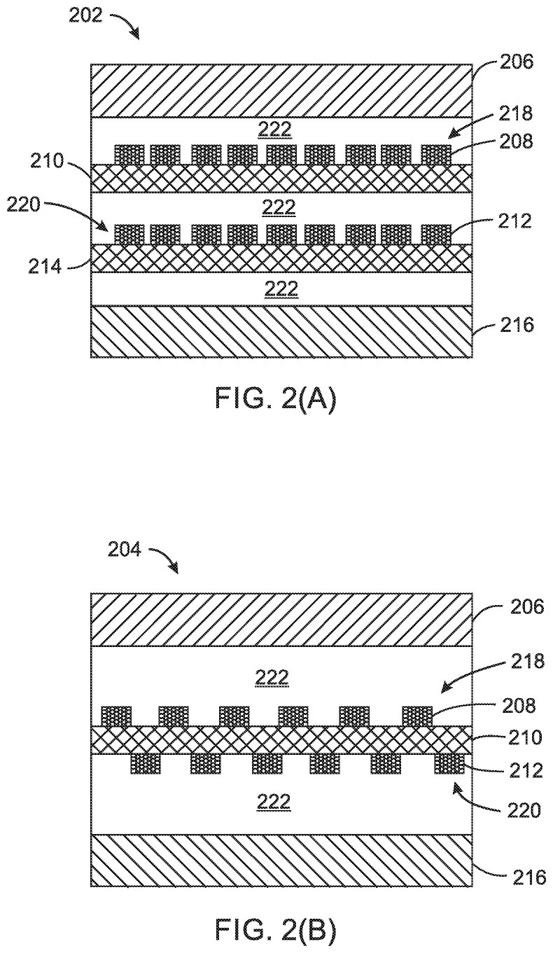

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Touch sensors made from nano-metallic wires, such as silver nano-wire (SNW), may provide a number of beneficial properties, including, optical transparency, electrically low resistance, flexibility or bendability, and low cost, among others. However, due to resistance, the channel lines in the busbar area may often need thicker conductors, which may limit the use of SNW in flexible or bendable applications.

Techniques disclosed herein provide an approach for using SNW for both the viewable sensor and the busbar channel areas. These techniques may retain the advantages of SNW solutions to form the conductors, such as optical properties, electrical properties, and cost, and may enhance its use in flexible or bendable applications, such as flexible displays. The basic principle is to utilize different density SNW material solutions to target the sensor and busbar areas respectively. This would better leverage the optical and electrical advantages of SNW within the sensor area, and the flexibility capabilities of this technology over the entire film, including both the sensor and busbar.

FIG. 1(A) is a drawing of an example of a component 100 that may be used in a touch sensor, according to an embodiment. The component 100 may be used to determine a location of an interaction between a device, for example, via a touch screen display or a touch pad, among others, and a conductive object, such as a finger, a stylus, and the like. For example, the interaction may include a finger that hovers over a touch screen display to select or manipulate content being displayed by the touch screen display. Thus, component 100 may be implemented in a computing platform such as a desktop computer, a notebook computer, a tablet computer, a convertible tablet, a personal digital assistant (PDA), a mobile Internet device (MID), a media player, a smart phone, a smart television (TV), a remote control, a radio, a videogame, and the like.

The component 100 may be included in a touch sensor structure such as a glass-only structure, a film-only structure, a glass-and-film structure, an on-cell structure, and so on. A glass-only structure may include, for example, a cover with one glass sensor (GG) structure, which may include a cover layer followed by a transmit and receive electrode layer, and a sensor layer. The GG structure may also include, for example, a cover layer followed by a receive electrode layer, a sensor layer, and a transmit electrode layer. The glass-only structure may include, for example, a one glass solution (OGS) structure, which may include a cover layer followed by a transmit and receive electrode layer. Very thin layers of glass may provide sufficient flexibility for structures described herein, however, higher flexibility may be achieved with the film-only structure.

The film-only structure may include, for example, a cover with two sensor film (GFF) structure, which may include a cover layer followed by a receive electrode layer, a first film layer, a transmit electrode layer, and a second film layer. The film-only structure may also include, for example, a cover with one electrode layer on each side of a sensor film (GF2) structure, which may include a cover layer followed by a receive electrode layer, a film layer, and a transmit electrode layer. The on-cell structure may include, for example, a touch sensor structure formed on a display module, such as a liquid crystal display (LCD), an organic light-emitting diode (OLED), and so on. In one example, the on-cell structure may include a touch sensor structure formed on a color-filter of an LCD, on an encapsulation layer of an OLED, and so on. In applications described herein, the component 100 may be included in flexible or bendable structures, such as film-only structures, or structures using very thin layers of glass, or both.

The component 100 may include a substrate 102, which may function as a cover in a touch sensor structure, a sensor in a touch sensor structure, a sensor film in a touch sensor structure, and so on. Accordingly, the substrate 102 may include a glass material for sensor applications for a touch screen display. The glass material may include quartz glass, non-alkali glass, crystallized transparent glass, soda-lime silica glass, chemically strengthened glass, heat strengthened glass, ion-exchange strengthened glass (e.g., potassium ion, alumino-silica, etc.), sapphire glass, and the like.

The substrate 102 may also include a polymer material for sensor applications for a touch screen display. The polymer material may include polyacrylates, polyethylene terephthalate (PET), cyclic olefin polymer (COP), cyclic olefin copolymer (COCP), polyimide (PI), polycarbonate (PC), triacetyl cellulose (TAC), and so on. In addition, a thickness of the substrate 102 may be controlled. For example, the thickness of the substrate 102 may be between about 50 μm and about 100 μm for a film implementation and between about 0.1 mm and about 0.4 mm for a glass implementation, although the substrate 102 may be formed including a smaller thickness or larger thickness for a film or a glass implementation.

As described herein, the component 100 includes sensor patterns 104 and busbar lines 106 that are formed of metal nanowires, such as SNW. The sensor patterns 104 may be formed over a viewing region while the busbar lines 106 are formed outside of the viewing region and used to electrically couple the sensor patterns 104 with platform hardware, such as sensor circuitry mounted on a printed circuit board (PCB). For example, one or more of the sensor patterns 104 may be coupled with a voltage driver to drive a voltage across the one or more of the sensor patterns 104, forming a drive or transmit electrode. In a further example, one or more of the sensor patterns 104 may be connected with an A/D converter to convert sense signals to digital representations thereof, forming a sense or receive electrode. In addition, one or more of the sensor patterns 104 may be coupled with a processor, such as a digital signal processor, a central processing unit, and the like, to determine a location corresponding to an interaction based on the sense signals. The sensor patterns 104 may be directly coupled with the busbar lines 106, for example, through an overlap in the metal nanowires forming the sensor patterns 104 and the busbar lines 106.

The sensor patterns 104 and busbar lines 106 may be formed of silver nanowire (SNW) networks. For example, SNW solutions may be obtained at concentrations of about 20 mg/ml to about 55 mg/ml having an average diameter of about 40 nm to about 400 nm and an average length of about 20 μm to about 200 μm, with silver purity of about 99.5%. The SNWs may be suspended in various solvents including alcohols or water, among others. Suppliers of SNW solutions may include ACS Material® of Medford, Mass., and Sigma-Aldrich® of St. Louis, Mo., among others. SNWs may also be fabricated by, for example, deposition, such as vapor deposition or electrodeposition, solution-phase synthesis, and the like. SNWs may be fabricated with a diameter less than about 40 nm, such as about 20 nm, 10 nm, and the like.

The resistance of a SNW structure is proportional to the density of the SNW solution used to form the structure. As described herein, different concentrations of SNW solutions may be used to form the sensor patterns 104 of the component 100 and the busbar lines 106. For the viewing area, there are some limitations to meet optical properties and sheet resistance targets. As used herein, sheet resistance may be directly measured using a four-terminal sensing measurement or other techniques. As sheet resistance is generally invariable under scaling it may be useful for comparing the resistance of devices of different sizes. Sheet resistance is expressed in units of ohms per square (Ω/sq). For example, the viewing area may have good optical properties at a sheet resistance level of 40 Ω/sq to 80 Ω/sq, which may be achieved using an SNW solution with a density of about 0.9 g/1000 g silver/solvent paste to about 1 g/1000 g silver/solvent paste. The busbar area may use a higher density to meet the lower resistance properties because the busbar lines 106 may be located underneath a bezel area, which is hidden from view. Considering the screen sizes, the busbar lines may be lower than 10 Ω/sq, which may be achieved using an SNW density of around 200 g/1000 g to about 300 g/1000 g silver/solvent paste.

A thickness of the sensor patterns 104 may be controlled by, for example, filtering different dispersion volumes to provide desired deposited masses, using specific fabrication processes and parameters thereof, such as evaporation processes, vacuum filtration processes, and the like. For example, the thickness of the sensor patterns 104 may be between about 10 nm and about 1 μm. In one example, a film having a mass per unit area (M/A) of about 47 mg/m2, providing a thickness of about 107 nm, may have a sheet resistivity of about 13 Ω/sq and an optical transmittance of about 85%. Thus, the sensor patterns 104 may be formed on the substrate 102 for use as electrodes in touch sensor applications such as sensor applications for a touch screen display.

The capacitance detected by using the component 100 may change as a function of the proximity of a conductive object to the component 100, wherein the sensor patterns 104 may be utilized to detect changes in capacitance. Accordingly, the component 100 may be utilized in a capacitance touch sensor. For example, the component 100 may be utilized in a surface capacitance touch sensor implementation, a self-capacitance touch sensor implementation, a mutual capacitance touch sensor implementation, and the like.

The sensor patterns 104 may have, for example, an optical transmittance of between about 85% and about 93%, and a sheet resistivity between about 10 Ω/sq and about 60 Ω/sq, or more, such as 250 Ω/sq. The sensor patterns 104 may also have a relatively higher flexibility, e.g., foldability or bendability, and a relatively low brittleness compared to inorganic oxide films, such as ITO films and ITO OGS. For example, the sensor patterns 104 may be subjected to a repeated bending angle between about 1 degree and about 160 degrees, or more, with minimized change in resistivity, e.g., less than about 2%, from its original state. Moreover, the sensor patterns 104 may have a haze of less than about 0.80%, and a color index of less than about 1.

Sensor patterns 104 may be formed using a fabrication rule to lower distortion and visibility of the sensor patterns 104. For example, the sensor patterns 104 may have an inter-pattern spacing of between about 1 μm and about 60 μm, and a pattern width 110 of between about 1 μm and 250 μm, to provide a specific visibility level that is suitable for a touch screen sensor application.

In the illustrated example, spaces 108 between the sensor patterns 104 physically separate the sensor patterns 104 from one another, which may lower the visibility of the sensor patterns 104. The spaces 108 may include a size of about 60 μm between two adjacent sensor patterns 104, a size of about 30 μm between two adjacent sensor patterns 104, a size of about 15 μm between two adjacent sensor patterns 104, a size of about 1 μm or less between two adjacent sensor patterns 14, and so on. The size of the spaces 108 may not be uniform across the device, for example, with smaller spaces used in areas that are more commonly used for input, and larger spaces in areas more commonly used for display.

The sensor patterns 104 and spaces 108 may be generated using any number of techniques. For example, a direct printing technique, such as screen printing, ink-jet printing, and the like, may provide an inter-pattern spacing having a size of about 10 μm. A photolithography technique may provide an inter-pattern spacing having a size of about 1 μm. Other techniques, such as reverse inkjet printing may be used to provide any number of sizes for the spaces 108. Thus, for example, the spaces 108 may each include a size of about 30 μm between adjacent sensor patterns 104.

In addition, the sensor patterns 104 include pattern widths 110 selected to lower the visibility of the sensor patterns 104. The pattern widths 110 may include a size of about 250 μm, a size of about 100 μm, a size of about 50 μm, a size of about 25 μm or less, and so on. For example, the pattern widths 110 may each include a size of about 100 μm.

FIG. 1(B) is a drawing of a touch sensor component that includes dummy patterns 114, according to an embodiment. The dummy patterns 114 may be formed of the same or different material as the sensor patterns 104. Accordingly, the dummy patterns 114 may include SNW networks to maintain flexibility of a touch sensor. The dummy patterns 114 may be fabricated using the same or different processes implemented to fabricate the active lines of the sensor patterns 104. In addition, the dummy patterns 114 may be fabricated at the same time or at a different time as when one or more of the sensor patterns 104 are fabricated. As used herein, an active line is a conductor in the pattern that is electrically coupled to transmit or receive circuits.

The dummy patterns 114 may reduce capacitance between adjacent sensor patterns 104. In addition, the dummy patterns 114 may maintain the sensor patterns 104 spaced apart from each other to lower the probability of physical contact between patterns. In the illustrated example, the dummy patterns 114 are formed have the same inter-pattern spacing and the pattern widths as the sensor patterns 104 and the dummy patterns 114.

FIGS. 2(A) and 2(B) are drawings of examples of touch sensor structures 202 and 204, according to embodiments. The touch sensor structure 202 includes a GFF structure for a mutual capacitance touch sensor implementation. Thus, the touch sensor structure 202 incudes a cover layer 206, a receive electrode layer 208, a film layer 210, a transmit electrode layer 212, and a film layer 214 on a display module 216. The display module 216 may include, for example, a color-filter of an LCD, an encapsulation of an OLED, and the like.

The cover layer 206 may include a glass material such as quartz glass, non-alkali glass, crystallized transparent glass, soda-lime silica glass, chemically strengthened glass, heat strengthened glass, ion-exchange strengthened glass, such as potassium ion or alumino-silica, among others, sapphire glass, and so on. The cover layer 206 may be a polymeric material, such as an acrylate, a polycarbonate, a polyester. Further, the film layers 210 and 214 may each include a polymer material, which may be the same or different type of polymer. For example, the film layers 210 and 214 may include a polyethylene terephthalate (PET), a cyclic olefin copolymer (COP), a polyisobutylene (PI), a polycarbonate (PC), a cellulose triacetate (TAC), and so on.

The illustrated receive electrode layer 208 includes receive electrode patterns 218 formed on one side of the film layer 210, for example, facing the cover layer 206. In addition, the illustrated transmit electrode layer 212 includes transmit electrode patterns 220 formed on the film layer 214 also facing the cover layer 206. Each of the electrode patterns 218 and 220 may be formed of a network of metal nanowires such as SNWs. Moreover, the electrode patterns 218 and 220 may be parallel and aligned with one another to form X, Y dimensions for the mutual capacitance touch sensor implementation.

In addition, an adhesive 222 may be disposed between two or more layers of the touch sensor structure 202 to adhere two or more adjacent layers. The adhesive 222 may include a same adhesive or a different adhesive throughout the touch sensor structures 202 and 204. The adhesive 222 may include pressure sensitive adhesive, a structural adhesive, and so on. In general, structural adhesives may harden via evaporation of solvent, reaction with UV radiation, chemical reaction, cooling, and so on. Pressure-sensitive adhesives (PSAs) may form a bond by an application of pressure to adhere the adhesive to a surface. The adhesive 222 may also include an optically clear adhesive (OCA), a liquid OCA (LOCA), and so on. Thus, in the touch sensor structure 202, the adhesive 222 that adheres the cover layer 206 to the receive electrode layer 208 may include an acrylic PSA while the adhesive 222 that adheres the transmit electrode layer 212 with the film layer 210 may include an epoxy PSA.

The touch sensor structure 204 illustrated in FIG. 2B includes a GF2 structure for a mutual capacitance touch sensor implementation. The touch sensor structure 204 may include the cover layer 206, the receive electrode layer 208, the film layer 210, and the transmit electrode layer 212 over the display module 216. The illustrated receive electrode layer 208 includes the receive electrode patterns 218 formed on a side of the film layer 210 that faces the cover layer 206. The illustrated transmit electrode layer 212 includes the transmit electrode patterns 220 formed on an opposite side of the film layer 210, facing the display module 216. Moreover, the illustrated electrode patterns 218 and 220 are parallel and alternating with one another to form X, Y dimensions for the mutual capacitance touch sensor implementation. Notably, the electrode patterns 218 and 220 may be in any desired position relative to each other, such as parallel (e.g., one-layer solution), orthogonal (e.g., two layers such as GFF and GF2), overlapping with variable angles, and so on.

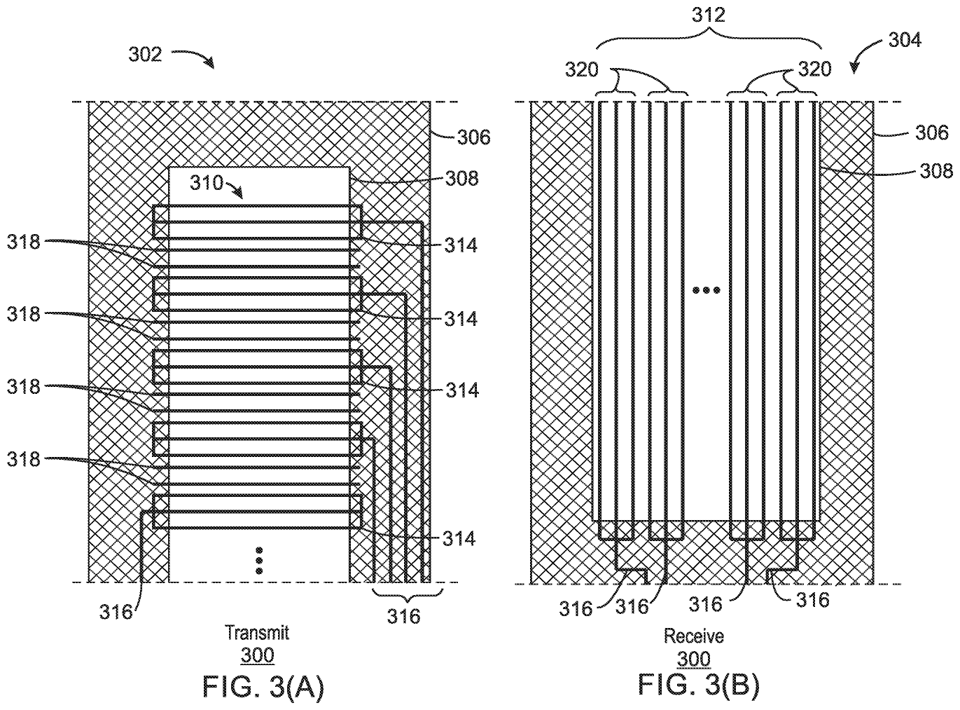

FIGS. 3(A) and 3(B) are drawings of an example of a touch sensor 300 including a touch sensor transmitter 302 and a touch sensor receiver 304 that may be used in embodiments. The touch sensor 300 may be used in a computing device, such as a smart phone, a tablet, an all-in-one PC, a control console, and the like. The touch sensor 300 includes a busbar region 306, which is blocked from a viewer, and a viewing region 308, which allows a display to show content. As described herein, optical characteristics like transparency, color shift, and haze may all be important in the viewing region 308, along with low resistance. The touch sensor 300 may be included in a sensor structure, such as GFF, GF2, and the like, for a mutual capacitance touch sensor implementation. The touch sensor transmitter 302 and the touch sensor receiver 304 have patterns 310 and 312 that may be orthogonal to one another to form X, Y dimensions for the mutual capacitance touch sensor implementation.

The transmit electrode patterns 310 may form a plurality of rows or columns as one of the X, Y dimensions for the mutual capacitance touch sensor. The transmit electrode patterns 310 may be disposed across substantially the entire area of the viewing region 308. The transmit electrode patterns 310 may include an inter-pattern spacing of between about 1 μm and about 60 μm and a pattern width of between about 1 μm and about 250 μm.

In example of FIG. 3(A), the inter-pattern spacing and the pattern width of the transmit electrode patterns 310 are the same size. In addition, at least a portion of the transmit electrode patterns 310 may be segmented into subsets 314 that are placed in series to reduce the resistance. This may increase the current that the busbar lines 316 may provide to the subsets 314, potentially increasing the efficiency and detection limits for the touch sensor 300. As described herein, the transmit electrode patterns 310 in the viewing region 308 may be formed from a low density solution of silver nanowires. Accordingly, the repeating of the subsets 314 may increase the current without substantially affecting the resolution.

In addition, dummy patterns 318 may be interspersed with the subsets 314. The dummy patterns 318 may be formed with the same inter-pattern spacing, specified pattern width, and the like, as used to form the transmit electrode patterns 310 to provide desired electrical properties, while potentially lowering the visibility of the transmit electrode patterns 310.

The transmit electrode patterns 310 in each of the subsets 314 may be electrically coupled to busbar lines 316 in the busbar region 306 to lower the possibility of malfunctions along an edge of the viewing region 308 when a conductive object approaches the touch sensor 300. The busbar lines 316 may connect the transmit electrode patterns 310 with other hardware components of the computing device, such as a voltage driver, analog-to-digital convertors (ADCs), and the like. As the busbar lines 316 in the busbar region 306 are not visible to a viewer, e.g., being located behind a bezel or other cover, the busbar lines 316 may be formed from a higher density solution of silver nanowires, as described herein.

FIG. 3(B) is an example of touch sensor receiver 304. In the touch sensor receiver 304, the receive electrode patterns 312 form a number of rows or columns as one of the X, Y dimensions for the touch sensor 300. The receive electrode patterns 312 may cover substantially the entire area of the viewing region 308. The receive electrode patterns 312 may include an inter-pattern spacing of between about 1 μm and about 60 μm and a pattern width between about 1 μm and about 250 μm. The inter-pattern spacing, the pattern width, or the periodicity may be the same or different for the receive electrode patterns 312 as the transmit electrode patterns 310. Further, as for the transmit electrode patterns 310, dummy patterns may be interspersed into the receive electrode patterns 312.

In the example of FIG. 3(B), the inter-pattern spacing and the pattern width of the receive electrode patterns 312 are the same size (e.g., repeat by a period of 1 sensor pattern). As for the transmit electrode patterns 310, at least a portion of the set of patterns may be segmented into subsets 320 that are electrically coupled in series to increase the current that may be provided through busbar lines 316.

As for the transmit electrode patterns 310, the receive electrode patterns 312 in each of the subsets 320 may be electrically coupled in the busbar region 306 to lower the probability of a malfunction at an edge of the viewing region 308 when a conductive object approaches the touch screen 300. The busbar lines 316 may be connected to other hardware components of the computing device, such as an A/D converter, a processor, and so on.

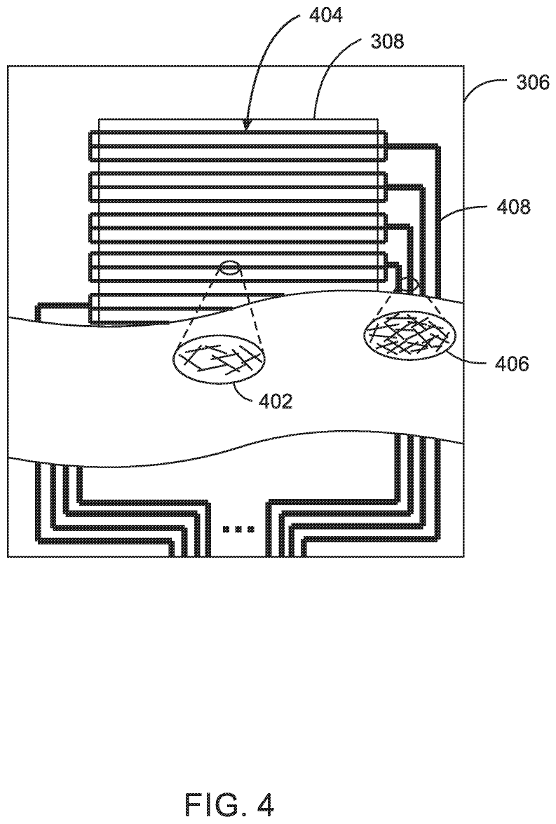

As for the touch sensor transmitter 302, the receive electrode patterns 312 in the viewing region 308 may be formed from a silver nanowire solution having a first density. The busbar lines 316 in the busbar region 306 may be formed from a silver nanowire solution having a second density. As the busbar lines 316 are not visible to a viewer, the second density may be higher than the first density. This is discussed further with respect to FIG. 4.

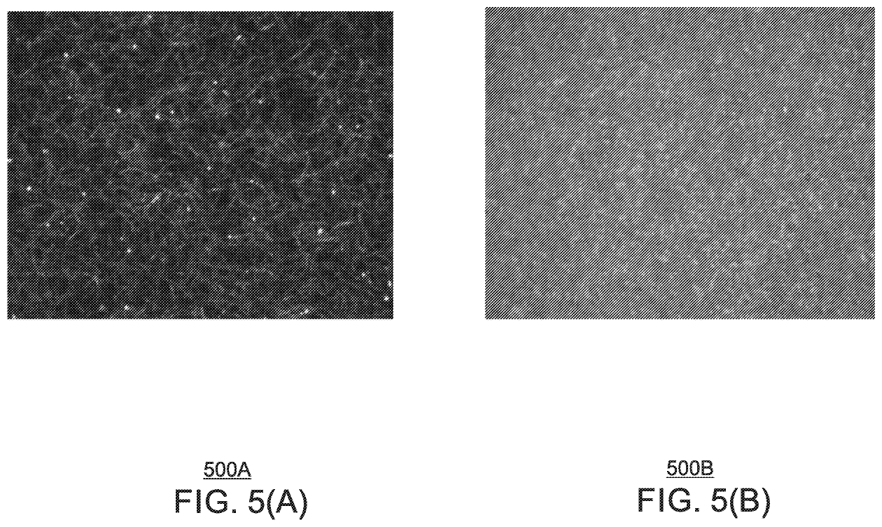

FIG. 4 is a drawing of an example of the use of lower density SNW 402 for the touch sensor patterns 404 in a viewing region 308 and higher density SNW 406 in the busbar lines 408 in a busbar region 306, according to embodiments. Like numbered items are as described with respect to FIGS. 3(A) and 3(B). The increased density in the busbar lines 408 lowers the resistance of the busbar lines 408 and, thus, increases the amount of current the busbar lines 408 can carry. The higher density may make the busbar lines 408 more visible, but, as described herein, they may be hidden underneath a bezel, device cover, or flexible case. The lower density used for the touch sensor patterns 404 may decrease the visibility of these patterns. The techniques were tested by the fabrication of SNW material solutions having a low density of SNW, e.g., about 1 g/1000 g silver/solvent paste and a high density of SNW, e.g., about 250 g/1000 g silver/solvent paste. These solutions were used to form regions of low and high densities of SNW as discussed with respect to FIGS. 5(A) and 5(B).

FIG. 5(A) is a drawing of an example of an electron micrograph 500A of a low density SNW region, according to an embodiment. The low density SNW has a resistance of about 60 ohm/sq.

FIG. 5(B) is a drawing of an example of an electron micrograph 500B of a high density SNW region, according to an embodiment. The high density SNW has a resistance of about 0.1 ohm/sq. Further, the low density SNW may have a lower visibility than the high density SNW, as indicated by the darker background in the electron micrograph 500A in FIG. 5(A).

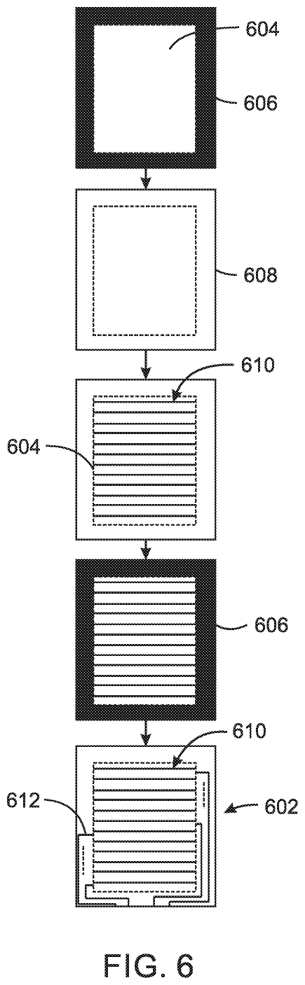

FIG. 6 is a schematic diagram of an example of forming a touch sensor 602 using different densities of SNW solutions for forming conductors in a touch sensor region 604 than in a busbar region 606, according to an embodiment. To begin, a low density SNW solution is used to coat the entire surface of the substrate 608 with a low density SNW solution. As the touch sensor region 604 is over the viewing area a high optical performance may be obtained by using a lower density solution. The coating may be performed by the number of techniques, for example, including slit coating, spin coating, roll to roll coating, sheet coating, inkjet printing, or any number of other techniques.

The touch sensor region 604 may then have the pattern 610 formed. The pattern 610 may be formed by reverse inkjet printing (RIP) method in which an etchant, such as a solvent, is printed on the negative pattern, e.g., over the spaces between conductors. The etchant suspends the SNWs in the spaces and, as it dries, may deposit the SNWs at the edges of conductors forming sharp lines between conductors and the spaces between conductors. Other techniques may be used to form the pattern 610. These may include direct inkjet printing of the conductors, screen printing, laser ablation patterning, or photo lithography, among others.

The busbar region 606 may then be coated using a high density SNW solution. This may be performed by protecting the touch sensor region 604, for example, by applying an adhesive for future assembly, by applying a protective coating, and the like. The busbar region 606 may then be coated using any of the techniques described herein, such as slit coating, spin coating, screen printing, or inkjet printing, among others. In some examples, the touch sensor region 604 does not need to be protected, for example, if the coating technique for the busbar region uses a targeted technique, such as inkjet printing.

As described herein, SNW solutions are available in high density, e.g., about 250 g/1000 g silver/solvent paste, to form layers at a thickness of about 3 to about 8 μm. These layers may be used for the busbar region 606 due to its low resistance. The high density SNW solution may have higher visibility, such as high haze, reflectance, color shift, or low light transmission if it is used for the touch sensor region 604 in the viewing area. However, the high density SNW solution provides low resistance making it suitable for areas that are not visible.

The busbar region 606 may then be patterned to form the busbar lines 612. The busbar lines 612 may not need a fine, or narrow line pattern, for example, if a wider Bezel or fewer channels are used. Accordingly, the busbar lines 612 may be formed using a direct printing method, such as inkjet printing. However, in applications in which a fine pattern, such as a high resolution or narrow bezel, is used, it may be more effective to use a laser patterning method after the high density SNW solution is coated on the film.

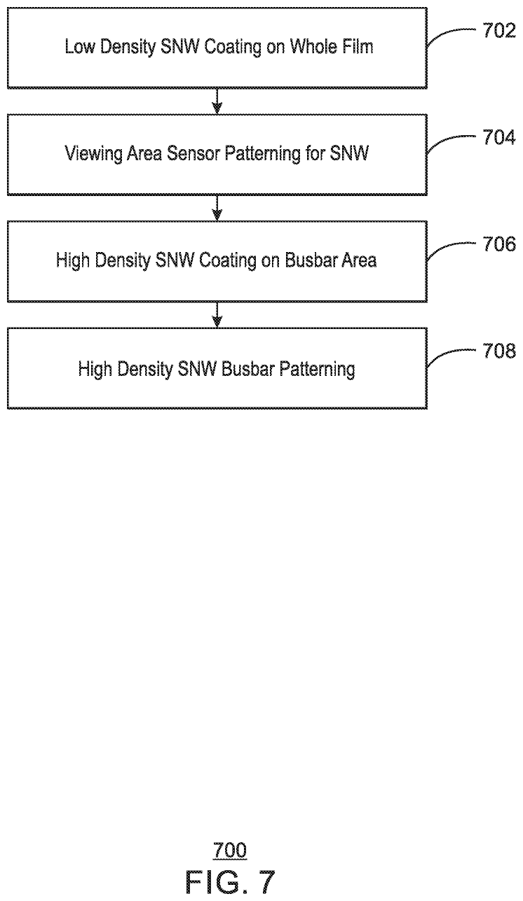

FIG. 7 is a process flow diagram of an example of a method 700 for forming a touch sensor using different densities of SNW for a touch sensor and for a busbar, according to an embodiment. The method may begin at block 702, when a low density SNW coating is applied to a substrate, covering both a touch sensor region and a busbar region. The coating may be performed by the techniques described with respect to FIG. 6. At block 704, a sensor may be patterned in the viewing area. This may be done by RIP, or other techniques, such as described with respect to FIG. 6.

At block 706, a high density SNW coating may be applied to the busbar region. In some examples, this may be performed by inkjet printing, or coating technique such as described with respect to FIG. 6. At block 708, the busbar lines in the busbar region may be patterned. This may be performed by RIP, laser ablation, photolithography, or any number of other techniques. As the high density SNW coating is applied over the low density SNW coating a separate electrical connection between the two coatings may not be used.

Techniques described herein are not limited to different densities of SNW, but may be used with other materials. Further, a material that allows for both low electrical resistance and sufficiently low visibility may be applied and patterned from a single coating, formed from a single application or multiple applications across the entire substrate.

The touch sensor of the viewing area and the busbar lines are not limited to a single material. For example, the touch sensor may be formed from ITO, while the busbar lines are formed from silver nanowire. This may allow some manufacturing or sourcing flexibility over other techniques while retaining availability of the touch sensor.

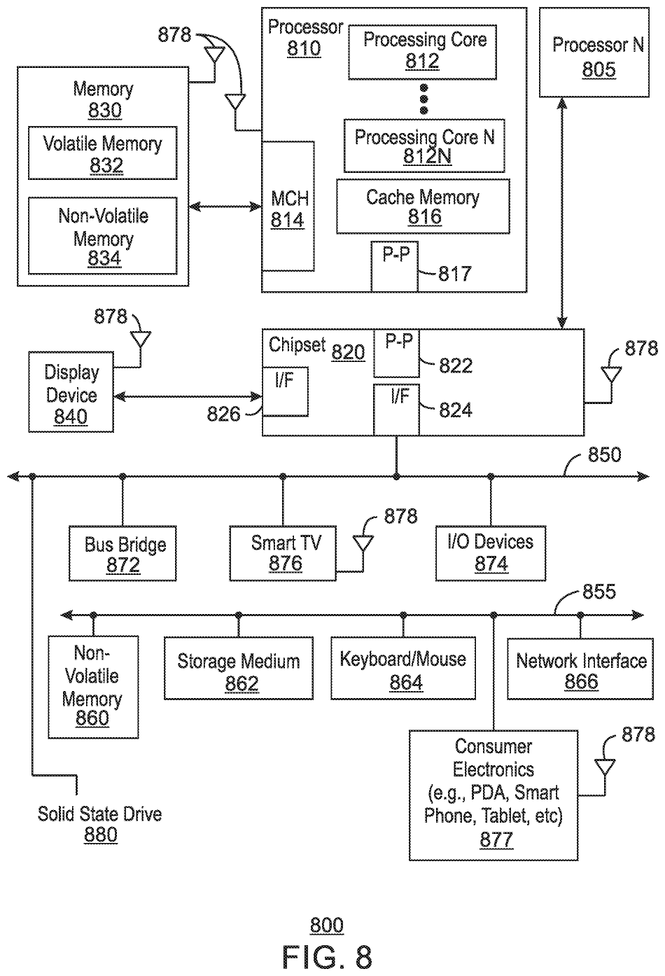

FIG. 8 is a block diagram of an example of a computing device 800 that may use the touch sensor described herein, according to an embodiment. For example, the computing device may use a flexible or bendable display formed using different densities of SNW, as described herein.

Referring to FIG. 8, the computing device 800 may include a desktop computer, a laptop computer, a netbook, a tablet, a notebook computer, a personal digital assistant (PDA), a server, a workstation, a cellular telephone, a mobile computing device, a smart phone, an Internet appliance, or any other type of computing device. The computing device 800 may implement the touch screen sensor disclosed herein and may be a system on a chip (SOC) system.

The processor 810 may have one or more processor cores 812 to 812N, where 812N represents the Nth processor core inside the processor 810 where N is a positive integer. The computing device 800 may include multiple processors including processors 810 and 805, where processor 805 has logic similar or identical to logic of processor 810. The computing device 800 may multiple processors including processors 810 and 805 such that processor 805 has logic that is completely independent from the logic of processor 810. In this example, a multi-package computing device 800 may be a heterogeneous multi-package system, because the processors 805 and 810 have different logic units. The processing core 812 may include, but is not limited to, pre-fetch logic to fetch instructions, decode logic to decode the instructions, execution logic to execute instructions and the like. The processor 810 may have a cache memory 816 to cache instructions or data of the computing device 800. The cache memory 816 may include level one, level two and level three, cache memory, or any other configuration of the cache memory within processor 810.

The processor 810 may include a memory control hub (MCH) 814, which is operable to perform functions that enable processor 810 to access and communicate with a memory 830 that includes a volatile memory 832 or a non-volatile memory 834. The memory control hub (MCH) 814 may be positioned outside of processor 810 as an independent integrated circuit.

The processor 810 may be operable to communicate with memory 830 and a chipset 820. In this example, the SSD 880 may execute the computer-executable instructions when the SSD 880 is powered up.

The processor 810 may be also coupled to a wireless antenna 878 to communicate with any device configured to transmit or receive wireless signals. An interface to a wireless antenna 878 may operate in accordance with, but is not limited to, the IEEE 802.11 standard and its related family, HomePlug AV (HPAV), Ultra-Wide Band (UWB), Bluetooth, WiMAX, or any form of wireless communication protocol.

The volatile memory 832 includes, but is not limited to, Synchronous Dynamic Random Access Memory (SDRAM), Dynamic Random Access Memory (DRAM), RAMBUS Dynamic Random Access Memory (RDRAM), or any other type of random access memory device. The non-volatile memory 834 includes, but is not limited to, flash memory (e.g., NAND, NOR), phase change memory (PCM), read-only memory (ROM), electrically erasable programmable read-only memory (EEPROM), or any other type of non-volatile memory device.

Memory 830 is included to store information and instructions to be executed by processor 810. This may include applications, operating systems, and device drivers. The chipset 820 may connect with processor 810 via Point-to-Point (PtP or P-P) interfaces 817 and 822. The chipset 820 may enable processor 810 to connect to other modules in the computing device 800. The interfaces 817 and 822 may operate in accordance with a PtP communication protocol such as the Intel QuickPath Interconnect (QPI) or the like.

The chipset 820 may be operable to communicate with processor 810, 805, display device 840, and other devices 872, 876, 874, 860, 862, 864, 866, 877, etc. The chipset 820 may be coupled to a wireless antenna 878 to communicate with any device configured to transmit or receive wireless signals.

The chipset 820 may connect to a display device 840 via an interface 826. The display device 840 may be formed by using silver nanowires at different densities. Further, the display device 840 may be flexible or bendable. The display device 840 may include, but is not limited to, a liquid crystal display (LCD), an organic light emitting diode (OLED), or any other form of visual display device.

In addition, the chipset 820 may connect to one or more buses 850 and 855 that interconnect various modules 874, 860, 862, 864, and 866. The buses 850 and 855 may be interconnected together via a bus bridge 872, for example, if there is a mismatch in bus speed or communication protocol. The chipset 820 couples with, but is not limited to, a non-volatile memory 860, a mass storage device(s) 862, a keyboard/mouse 864, and a network interface 866 via interface 824, smart TV 876, consumer electronics 877, etc.

The mass storage device 862 includes, but is not limited to, a solid state drive, a hard disk drive, a universal serial bus flash memory drive, or any other form of computer data storage medium. The network interface 866 may be implemented by any type of well-known network interface standard including, but not limited to, an Ethernet interface, a universal serial bus (USB) interface, a Peripheral Component Interconnect (PCI) Express interface, a wireless interface and/or any other suitable type of interface.

While the modules shown in FIG. 8 are depicted as separate blocks within the computing device 800, the functions performed by some of these blocks may be integrated within a single semiconductor circuit or may be implemented using two or more separate integrated circuits.

### EXAMPLE

Example 1 includes an apparatus, including a touch sensor, wherein the touch sensor includes a busbar region that includes busbar lines formed from metallic nanowires at a first density.

Example 2 includes the subject matter of example 1. In this example, the apparatus includes a touch screen display that includes the touch sensor.

Example 3 includes the subject matter of either of examples 1 or 2. In this example, the apparatus includes a flexible display.

Example 4 includes the subject matter of any of examples 1 to 3. In this example, the apparatus includes a bendable display.

Example 5 includes the subject matter of any of examples 1 to 4. In this example, the apparatus includes a film only structure.

Example 6 includes the subject matter of any of examples 1 to 5. In this example, the apparatus includes a cover layer, a receive electrode layer, a film layer, a transmit electrode layer, a second film layer, and a display module.

Example 7 includes the subject matter of any of examples 1 to 6. In this example, the apparatus includes a cover layer, a receive electrode layer, a film layer, a transmit electrode layer, and a display module.

Example 8 includes the subject matter of any of examples 1 to 7. In this example, the apparatus includes a sensor region that includes patterns formed from metallic nanowires at a second density.

Example 9 includes the subject matter of any of examples 1 to 8. In this example, the apparatus includes silver nanowires.

Example 10 includes the subject matter of any of examples 1 to 9. In this example, the apparatus includes a first density of metallic nanowires that is higher than a second density of metallic nanowires.

Example 11 includes the subject matter of any of examples 1 to 10. In this example, the apparatus includes patterns in a sensor region that are grouped into sub-patterns, wherein the sub-patterns include multiple lines electrically coupled to one another to form a parallel circuit.

Example 12 includes the subject matter of any of examples 1 to 11. In this example, the apparatus includes patterns in a sensor region that include an active line that is coupled to circuitry and a dummy line that is not coupled to circuitry.

Example 13 includes the subject matter of any of examples 1 to 12. In this example, the apparatus includes a sensor region that includes a dummy line disposed between two active lines.

Example 14 includes a method for making a touch sensor, including coating a low density silver nanowire solution over a substrate, patterning a sensor region on the substrate, coating a high density silver nanowire solution over a busbar area, and patterning the busbar area.

Example 15 includes the subject matter of example 14. In this example, patterning includes using reverse inkjet printing to apply a solvent to remove silver nanowires.

Example 16 includes the subject matter of either of examples 14 or 15. In this example, patterning includes using photolithography to remove silver nanowires.

Example 17 includes the subject matter of any of examples 14 to 16. In this example, patterning includes using laser ablation to remove silver nanowires.

Example 18 includes the subject matter of any of examples 14 to 17. In this example, the method includes attaching a display to the touch sensor.

Example 19 includes the subject matter of any of examples 14 to 18. In this example, the method includes forming the pattern in the sensor region into sub-patterns, wherein a sub-pattern includes two or more lines that are electrically coupled in series.

Example 20 includes the subject matter of any of examples 14 to 19. In this example, the method includes patterning the busbar area by printing bus lines using an inkjet printer.

Example 21 includes the subject matter of any of examples 14 to 20. In this example, the method includes forming a dummy line, wherein the dummy line is not electrically coupled to circuitry.

Example 22 includes an apparatus, including a touch sensor, wherein the touch sensor includes a busbar region that includes patterns formed from silver nanowires at a first density, and a sensor region including patterns formed from the silver nanowires at a second density, wherein the first density is higher than the second density.

Example 23 includes the subject matter of example 22. In this example, the apparatus includes a computing device that includes the touch sensor.

Example 24 includes the subject matter of either of examples 22 or 23. In this example, the apparatus includes a display that includes the touch sensor.

Example 25 includes the subject matter of any of examples 22 to 24. In this example, the apparatus includes a display that is flexible.

Example 26 includes an apparatus, including means to perform any one of the methods of claims 14 to 21.

Example 27 includes a touch screen display, including a touch sensor. The touch sensor includes a busbar region that includes patterns formed from silver nanowires at a first density, and a sensor region including patterns formed from the silver nanowires at a second density, wherein the first density is higher than the second density. The touch screen display also includes a display panel, wherein the display panel is affixed to one side of the touch sensor and is configured to be viewed from the other side of the touch sensor.

Example 28 includes the subject matter of example 27. In this example, the touch screen display includes a computing device that includes the touch screen display, wherein the computing device includes a smart phone, a tablet computer, a laptop computer, an all-in-one computer, or a monitor.

Example 29 includes the subject matter of either of examples 27 or 28. In this example, the touch screen display is flexible.

Example 30 includes the subject matter of any of examples 27 to 29. In this example, the touch screen display is bendable.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the techniques. The various appearances of “an embodiment”, “one embodiment”, or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

1-30. (canceled)

31. An apparatus, comprising a touch sensor, wherein the touch sensor comprises a busbar region comprising busbar lines formed from metallic nanowires at a first density.

32. The apparatus of claim 31, comprising a touch screen display comprising the touch sensor.

33. The apparatus of claim 31, comprising a flexible display.

34. The apparatus of claim 31, comprising a bendable display.

35. The apparatus of claim 31, comprising a film only structure.

36. The apparatus of claim 31, comprising a cover layer, a receive electrode layer, a film layer, a transmit electrode layer, a second film layer, and a display module.

37. The apparatus of claim 31, comprising a cover layer, a receive electrode layer, a film layer, a transmit electrode layer, and a display module.

38. The apparatus of claim 31, comprising a sensor region comprising patterns formed from the metallic nanowires at a second density.

39. The apparatus of claim 38, wherein the metallic nanowires comprise silver nanowires.

40. The apparatus of claim 38, wherein the first density is higher than the second density.

41. The apparatus of claim 38, wherein the patterns comprising the sensor region are grouped into sub-patterns, wherein the sub-patterns comprise multiple lines electrically coupled to one another to form a parallel circuit.

42. The apparatus of claim 38, wherein the patterns comprising the sensor region comprises an active line that is coupled to circuitry and a dummy line that is not coupled to circuitry.

43. The apparatus of claim 42, wherein the dummy line is disposed between two active lines.

44. A method for making a touch sensor, comprising:
coating a low density silver nanowire solution over a substrate;
patterning a sensor region on the substrate;
coating a high density silver nanowire solution over a busbar area; and
patterning the busbar area.

45. The method of claim 44, wherein patterning comprises using reverse inkjet printing to apply a solvent to remove silver nanowires.

46. The method of claim 44, wherein patterning comprises using photolithography to remove silver nanowires.

47. The method of claim 44, wherein patterning comprises using laser ablation to remove silver nanowires.

48. The method of claim 44, comprising attaching a display to the touch sensor.

49. The method of claim 44, comprising forming the pattern in the sensor region into sub-patterns, wherein a sub-pattern comprises two or more lines that are electrically coupled in series.

50. The method of claim 44, comprising patterning the busbar area by printing bus lines using an inkjet printer.

51. The method of claim 44, comprising forming a dummy line, wherein the dummy line is not electrically coupled to circuitry.

52. An apparatus, comprising a touch sensor, wherein the touch sensor comprises:
a busbar region comprising patterns formed at a first density of silver nanowires; and
a sensor region comprising patterns formed at a second density of silver nanowires,
wherein the first density is higher than the second density.

53. The apparatus of claim 52, comprising a computing device comprising the touch sensor.

54. The apparatus of claim 52, comprising a display comprising the touch sensor.

55. The apparatus of claim 54, wherein the display is flexible.
